(19) United States
(12) Patent Application Publication
(10) Pub. No.: US 2025/0284033 A1
(43) Pub. Date: Sep. 11, 2025

(54) LENS AND MANUFACTURING METHOD THEREOF

(71) Applicant: SAMSUNG ELECTRO-MECHANICS CO., LTD., Suwon-si (KR)

(72) Inventors: Jong Hyouk KIM, Suwon-si (KR); Jae Hong LEE, Suwon-si (KR); Dong Hyeon WON, Suwon-si (KR); Young Jin HWANG, Suwon-si (KR)

(73) Assignee: SAMSUNG ELECTRO-MECHANICS CO., LTD., Suwon-si (KR)

(21) Appl. No.: 19/053,670

(22) Filed: Feb. 14, 2025

(30) Foreign Application Priority Data
Mar. 7, 2024 (KR) 10-2024-0032635
Oct. 2, 2024 (KR) 10-2024-0134109

(51) Int. Cl. G02B 1/111; G02B 1/12

(52) U.S. Cl. CPC G02B 1/111; G02B 1/12

(57) ABSTRACT

A lens includes a lens portion, a metal oxide layer including a metal oxide and disposed on a surface of the lens portion, a buffer layer including SiO and Cr and disposed on a surface of the metal oxide layer, and a fluorinated organic layer disposed on a surface of the buffer layer.

### CROSS-REFERENCE TO RELATED APPLICATIONS

This application claims the benefit under 35 USC 119(a) of Korean Patent Application Nos. 10-2024-0032635 filed on Mar. 7, 2024, and 10-2024-0134109 filed on Oct. 2, 2024, in the Korean Intellectual Property Office, the entire disclosures of which are incorporated herein by reference for all purposes.

### BACKGROUND

### 1. Field

The present disclosure relates to a lens and a manufacturing method thereof.

### 2. Description of the Background

In order to reduce the reflectivity of lenses, an anti-reflection coating is applied to the surfaces of lenses. In the related art, the anti-reflection coating is formed by alternately depositing and laminating two types of materials having a high refractive index and a low refractive index.

However, since the refractive index of a thin film deposited in this manner is based on the unique characteristics of materials, the range of adjustment may be narrow and there may be a limit to the reduction in reflectivity that may be achieved.

In particular, in the recent lens market, a level of low reflectivity that is impossible with such an anti-reflection coating of a multilayer thin film structure may be desired, and thus, a new type of anti-reflection coating is needed.

To meet demand, a nanostructured anti-reflection coating technology has been disclosed.

The nanostructured anti-reflection coating is a method of forming voids in a thin film to lower an effective refractive index.

Here, if the ratio of voids to the total volume of the thin film is gradually increased, a layer called “graded-index-material” may be formed, and an anti-reflection coating that ideally converges to a reflectivity of “0” may be made.

Such a nanostructured anti-reflection coating may be largely divided into two manufacturing methods: a dry method and a wet method.

The wet method involves a chemical reaction in the process of nanostructuring a vacuum-deposited thin film.

Generally, industry adopts the wet method based on water, which is easy to manage, but there is a problem of deterioration over time due to moisture in the air and a decrease in yield due to reaction residues.

In addition, in the case of the dry method, an organic layer is deposited on an oxide layer, and when different types of thin films are alternately deposited and left in a high temperature (85° C.) and high humidity (85%) environment for a reliability test, the phenomenon in which the two layers are separated due to a difference in thermal coefficients is observed, which causes an increase in a defect rate.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a lens includes a lens portion, a metal oxide layer including a metal oxide and disposed on a surface of the lens portion, a buffer layer including SiO and Cr and disposed on a surface of the metal oxide layer, and a fluorinated organic layer disposed on a surface of the buffer layer.

The metal oxide layer may include SiO₂.

The fluorinated organic layer may be formed of TEFLON.

In another general aspect, a lens includes a lens portion, a metal oxide layer including a metal oxide and disposed on a surface of the lens portion, a buffer layer disposed on a surface of the metal oxide layer, and a fluorinated organic layer disposed on a surface of the buffer layer, wherein the fluorinated organic layer has an uneven portion formed on an upper surface thereof.

The uneven portion may have an etched irregular shape obtained by etching.

The buffer layer may include SiO.

The buffer layer may include SiO and Cr.

In another general aspect, a method of manufacturing a lens includes depositing a metal oxide on a substrate to form a metal oxide layer, depositing a metal material on the metal oxide layer to form a buffer layer, depositing a fluorinated organic material on the buffer layer to form a fluorinated organic layer, coating a thin film on the fluorinated organic layer, and performing accelerated ion etching on the thin film so that the fluorinated organic layer has irregular recesses formed from an upper surface toward a lower surface of the fluorinated organic layer.

Other features and aspects will be apparent from the following detailed description, the drawings, and the claims.

### BRIEF DESCRIPTION OF DRAWINGS

FIG. 1 is a cross-sectional view schematically illustrating a laminated structure of a lens according to an example embodiment of the present disclosure.

FIGS. 2 to 4 are cross-sectional views sequentially illustrating a process of manufacturing a lens according to an example embodiment of the present disclosure.

FIG. 5 is a graph showing comparison between the reflectivity of a fluorinated organic layer when a buffer layer is not applied and the reflectivity of a fluorinated organic layer when a buffer layer is applied.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An aspect of the present disclosure is to provide a lens and a manufacturing method thereof, capable of improving a film lifting phenomenon occurring after a reliability test, while manufacturing a lens having a nanostructured anti-reflection coating structure by a dry method.

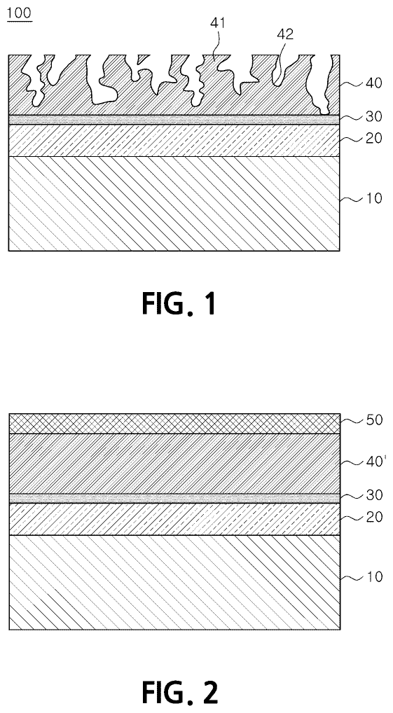

FIG. 1 is a cross-sectional view schematically illustrating a laminated structure of a lens according to an example embodiment of the present disclosure.

Referring to FIG. 1, a lens 100, according to an example embodiment of the present disclosure, has a nanostructured anti-reflection coating structure using dry etching and includes a lens portion, a metal oxide layer, a buffer layer, and a fluorinated organic layer.

The lens portion 10 may include a substrate.

The shape or type of the lens portion 10 is not particularly limited and may be implemented in the form of a lens that may be used in an optical device, such as a camera module.

In addition, the lens portion 10 may be formed of glass. However, the lens portion 10 may be formed of a material other than glass and may be formed of, for example, a plastic resin including a resin component.

The plastic resin may include at least one component among polycarbonate and polyolefin.

Here, the polyolefin may include at least one of a cycloolefin polymer and a cycloolefin copolymer.

The metal oxide layer 20 includes a metal oxide having excellent anti-reflection properties and is disposed on one surface of the lens portion 10.

Here, the metal oxide layer 20 may be formed of a material including SiO₂.

The metal oxide layer 20 may be formed on the lens portion 10 using various deposition methods, such as atomic layer deposition (ALD), chemical vapor deposition (CVD), physical vapor deposition (PVD), or the like.

The buffer layer 30 is disposed on one surface of the metal oxide layer 20.

In addition, the buffer layer 30 may be formed of a material including SiO.

In addition, as another example embodiment, the buffer layer 30 may be formed of a metal mixed material including SiO and Cr.

The buffer layer 30 may be formed on the metal oxide layer 20 using various deposition methods, ALD, CVD, PVD, or the like.

The buffer layer 30 provides bonding strength and prevents the metal oxide layer 20 and the fluorinated organic layer 40 from being lifted after a reliability test under high temperature and high pressure conditions.

The fluorinated organic layer 40 is disposed on one surface of the buffer layer 30.

The fluorinated organic layer 40 may include an organic material including a fluorine group with excellent antireflection properties and may be formed on the buffer layer 30 using various deposition methods, such as ALD, CVD, PVD, or the like.

Here, the fluorinated organic layer 40 may be formed of TEFLON, which has a relatively high melting point, making it advantageous for deposition, and is easy to obtain as a material, and may reproducibly obtain a desired etching effect.

In addition, the fluorinated organic layer 40 has an uneven portion 41 formed on an upper surface thereof.

Here, at least a portion of a recess portion 42 between the uneven portions 41 may extend to an upper surface of the buffer layer 30. Here, the uneven portion is formed only in the fluorinated organic layer and is not formed in the metal oxide layer.

When the fluorinated organic layer 40 is formed of TEFLON, the recess portion 42 has a refractive index of about 1 corresponding to the refractive index of air, and the uneven portion 41 without the recess portion 42 has a refractive index of about 1.37, which is the refractive index of TEFLON. When viewed from a horizontal direction in FIG. 1, the fluorinated organic layer 40 has a refractive index of about the average of the recess portion 42 and the uneven portion 41.

In addition, the uneven portion 41 is formed by etching and may be formed to have an overall regular shape, or as another example, may be formed to have an irregular shape.

The irregular shape of the uneven portion 41 means that the length, width, and depth of each recess portion 42 recessed in a thickness direction of the uneven portion 41 are formed to be different.

The fluorinated organic layer 40 may reduce the reflectivity of the lens 100 by scattering light incident on the lens 100 due to the uneven surface structure.

As for the fluorinated organic layer 40, a thin film 50 of less than 10 nm may be formed on the surface of the fluorinated organic layer 40, and when accelerated ion etching is performed on the thin film 50, a portion of the upper surface of the fluorinated organic layer 40 may be etched, thereby forming the irregular uneven portion 41.

In the lens 100 configured in this manner, the buffer layer 30 is disposed between the fluorinated organic layer 40 formed of an organic material and the metal oxide layer 20 formed of an inorganic material, thereby increasing the adhesion between the metal oxide layer 20 and the fluorinated organic layer 40.

Therefore, the optical characteristics of the lens 100 may be improved by the dry nanostructured anti-reflection coating, while the film lifting phenomenon that may occur after a high temperature and high humidity reliability test may be prevented by the buffer layer 30 disposed between the fluorinated organic layer 40 and the metal oxide layer 20, thereby improving a defect rate.

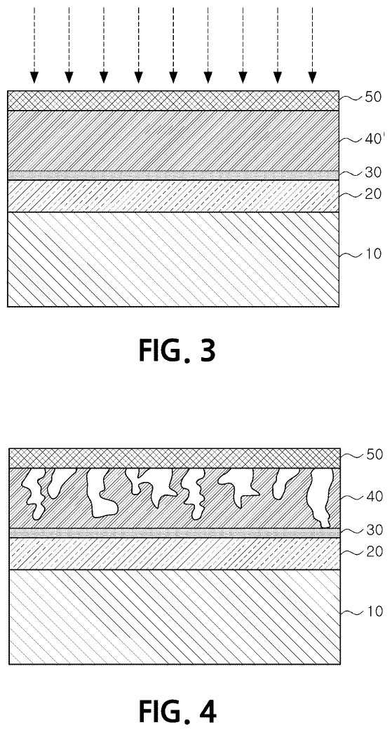

Referring to FIGS. 2 to 4, in order to manufacture the lens 100 having such a configuration, first, a metal oxide is deposited on the lens portion 10 formed as a substrate to form the metal oxide layer 20, and then a metal material is deposited on the metal oxide layer 20 to form the buffer layer 30.

Next, a fluorinated organic material is deposited on the buffer layer 30 to form a fluorinated organic material base layer 40′, and the thin film 50 is coated on the fluorinated organic material base layer 40′.

Thereafter, accelerated ion etching is performed on the thin film 50 to form the fluorinated organic material layer 40 having the irregular uneven portion 41 formed to dig from the upper surface of the fluorinated organic material base layer 40′ downward, thereby manufacturing the lens 100 with improved adhesion between the organic material layer and the inorganic material layer.

The related art lens having a dry nanostructured anti-reflection coating structure has a configuration in which an organic material layer is deposited on an oxide layer, and since the bonding strength of the oxide layer and the organic material layer is weak, if different types of thin films are alternately deposited and then left in a high temperature (85° C.) and high humidity (85%) environment for a reliability test, a phenomenon of separation between the two thin films is observed, resulting in an increase in the defect rate.

However, according to an example embodiment, the buffer layer 30 may increase the bonding strength between the fluorinated organic layer 40 and the oxide layer 20, thereby resolving the low bonding strength between the organic layer and the oxide layer in the related art dry nanostructure anti-reflection coating, thereby improving the film lifting phenomenon occurring after an environmental reliability test, and thus significantly reducing the defect rate.

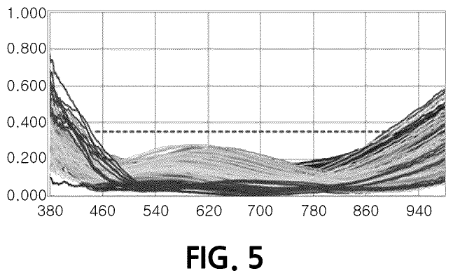

Meanwhile, FIG. 5 is a graph showing comparison between the reflectivity of a fluorinated organic layer when a buffer layer is not applied and the reflectivity of a fluorinated organic layer when a buffer layer is applied, which is a cumulative graph of the reflectivity after 20 repeated coatings, in which the X-axis is the wavelength, the Y-axis is the reflectivity, and each line represents a dispersion level of the coating reflectivity during mass-production in the coating process.

Referring FIG. 5, it can be seen that, even when the buffer layer is applied according to an example embodiment of the present disclosure, there is no significant decrease in reflectivity, so the transmittance of the lens may be maintained at a certain level.

The lens, according to an example embodiment of the present disclosure, is configured as a lens having a nanostructured anti-reflection coating structure in a dry manner and has the effect of preventing a film lifting phenomenon occurring when a reliability test is performed on the related art lens having a dry nanostructured anti-reflection coating structure.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens comprising:
a lens portion;
a metal oxide layer including a metal oxide and disposed on a surface of the lens portion;
a buffer layer including SiO and Cr and disposed on a surface of the metal oxide layer; and
a fluorinated organic layer disposed on a surface of the buffer layer.

2. The lens of claim 1, wherein the metal oxide layer includes SiO₂.

3. The lens of claim 1, wherein the fluorinated organic layer is formed of TEFLON.

4. A lens comprising:
a lens portion;
a metal oxide layer including a metal oxide and disposed on a surface of the lens portion;
a buffer layer disposed on a surface of the metal oxide layer; and
a fluorinated organic layer disposed on a surface of the buffer layer,
wherein the fluorinated organic layer has an uneven portion formed on an upper surface thereof.

5. The lens of claim 4, wherein the uneven portion has an etched irregular shape obtained by etching.

6. The lens of claim 4, wherein the buffer layer includes SiO.

7. The lens of claim 4, wherein the buffer layer includes SiO and Cr.

8. The lens of claim 4, wherein the metal oxide layer includes SiO₂.

9. The lens of claim 4, wherein the fluorinated organic layer is formed of TEFLON.

10. A method of manufacturing a lens, the method comprising:
depositing a metal oxide on a substrate to form a metal oxide layer;
depositing a metal material on the metal oxide layer to form a buffer layer;
depositing a fluorinated organic material on the buffer layer to form a fluorinated organic layer;
coating a thin film on the fluorinated organic layer; and
performing accelerated ion etching on the thin film so that the fluorinated organic layer has irregular recesses formed from an upper surface toward a lower surface of the fluorinated organic layer.
